(19) United States
(12) Patent Application Publication
(10) Pub. No.: US 2005/0264600 A1
(43) Pub. Date: Dec. 1, 2005

(54) Emission of fluid droplet from printhead with coherent irradiation

(75) Inventors: John R. Moffatt, Corvallis, OR (US); Hiang P. Lauw, Corvallis, CO (US); Bun Chay Te, Corvallis, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/854,889

(22) Filed: May 27, 2004

(51) Int. Cl. B41J 2/165

(52) U.S. Cl. 347/33

(57) ABSTRACT

A fluid ejection device is irradiated with an effective amount of coherent radiation to cause emission of a fluid droplet from the fluid ejection device.

### BACKGROUND

Ink-jet printing is a non-impact printing process in which droplets of ink are deposited on print media, such as paper, transparency film, or textiles. Low cost and high quality of the output, combined with relatively noise-free operation, have made ink-jet printers a popular alternative to other types of printers used with computers. Ink-jet printing involves the ejection of fine droplets of ink onto print media in response to electrical signals generated by a microprocessor.

Two conventional approaches for achieving ink droplet ejection in ink-jet printing include thermal and piezoelectrical-based approaches. In thermal ink-jet printing, the energy for drop ejection is generated by electrically-heated resistor elements, which heat up rapidly in response to electrical signals from a microprocessor to create a vapor bubble, resulting in the expulsion of ink through nozzles associated with the resistor elements. In piezoelectric ink-jet printing, the ink droplets are ejected due to the vibrations of piezoelectric crystals, again, in response to electrical signals generated by the microprocessor.

### BRIEF DESCRIPTION OF THE DRAWINGS

The numbering scheme for the Figures included herein are such that the leading number for a given reference number in a Figure is associated with the number of the Figure. For example, a system 100 can be located in FIG. 1. However, reference numbers are the same for those elements that are the same across different Figures. In the drawings:

FIG. 1 illustrates a system for fluid propelled by coherent radiation-induced blowing agents, according to some embodiments.

FIG. 2 illustrates a more detailed diagram of a system for fluid propelled by coherent radiation-induced blowing agents, according to some embodiments

FIG. 3 illustrates a more detailed diagram of a printhead for fluid propelled by coherent radiation-induced blowing agents, according to some embodiments.

FIG. 4 illustrates a more detailed block diagram of an alternative view of a printhead for fluid propelled by coherent radiation-induced blowing agents, according to some embodiments.

FIG. 5 illustrates a flow diagram of operations for propelling fluid by coherent radiation-induced blowing agents, according to some embodiments.

### DETAILED DESCRIPTION

Methods, apparatus and systems for fluid propelled by coherent radiation-induced blowing agents are described. In the following description, numerous specific details are set forth. However, it is understood that embodiments may be practiced without these specific details. In other instances, well-known circuits, structures and techniques have not been shown in detail in order not to obscure the understanding of this description. While described with reference to use in a fluid ejection system, embodiments are not so limited. For example, embodiments may be used in printers, copiers, scanners, and other fluid ejection systems.

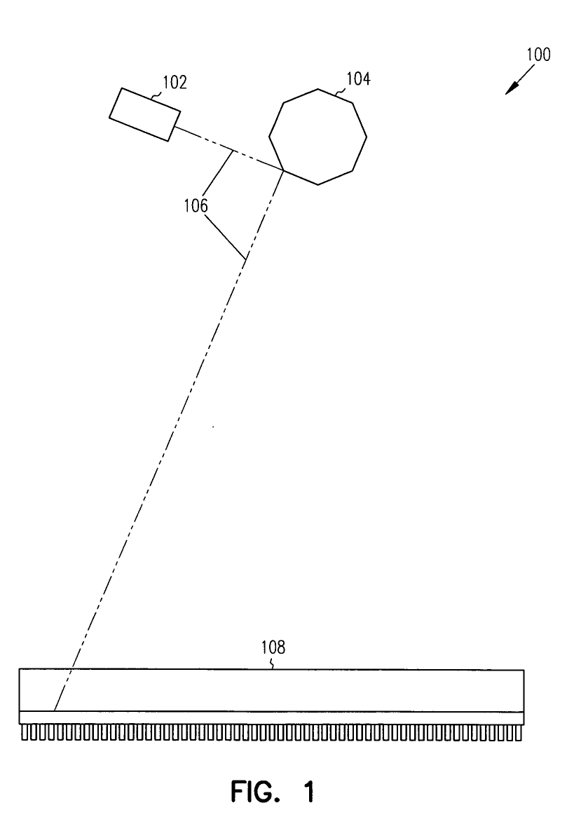

FIG. 1 illustrates a system for fluid, such as ink, propelled by coherent radiation-induced blowing agents, according to some embodiments. The system 100 includes a coherent radiation source 102, a mirror 104 and a fluid ejection device 108, such as a printhead. In operation, the coherent radiation source 102 emits coherent radiation 106 that is reflected off the mirror 104 toward the fluid ejection device 108. The fluid ejection device 108 may include different reservoirs for the storage of an ink or fluid medium. The fluid ejection device 108 may also include one to a number of different orifices for the expulsion of fluid from the fluid ejection device 108 onto a print media.

As further described below, the energy from the coherent radiation 106 induces (through heat and/or light) blowing or ejecting of the fluid out from one or more of the orifices of the fluid ejection device 108 onto a print media. In some embodiments, the fluid may include a blowing agent, which acts upon application of the energy supplied by the coherent radiation 106.

The mirror 104 may be controlled by different types of control logic (such as instructions executed by a microprocessor (not shown), different types of hardware logic, a combination of software and hardware, etc.). For example, the mirror 104 may be controlled to reflect the coherent radiation 106 to different parts of the fluid ejection device 108. Accordingly, such control logic may cause the fluid to be output through different orifices of the fluid ejection device 108 onto different locations of the print media.

The coherent radiation 106 may be a (Light Amplification by Simulated Emission of Radiation) LASER light source, light emitting diode signal or any other type of focused light source. The coherent radiation source 102 may be different types of LASER light sources. For example, the coherent radiation source may be a semiconductor LASER light source, a gas LASER light source, etc.

The coherent radiation 106 may have different combinations of various attributes (such as different wavelengths, different pulse durations, different diffusion wave travel times, different diffusion times, different absorption lengths and different coherent radiation spot sizes). As further described below, in some embodiments, these various attributes are based on different attributes of the fluid ejection device 108 (such as the thickness layer of the fluid, the backing plate thickness, the orifice size, etc.).

The coherent radiation 106 may have a wavelength of 193 nanometers (nm), 248 nm, 337 nm, 488 nm, 514 nm, 543 nm, 633 nm, 570-650 nm, 694 nm, 1064 nm, 10600 nm, etc. The coherent radiation 106 may have a pulse duration from 7.5 nanoseconds (ns)-10.0 ns, 6.0 ns-9.5 ns, 3.1 ns-8.1 ns, etc. The coherent radiation 106 may have a wave travel time of 40.24 ns, 35.2 ns, 25.2 ns, etc. The coherent radiation 106 may have a diffusion time of 1.19×10⁶ ns, 2.1×10⁶ ns, etc. The coherent radiation 106 may have an absorption length of 10 micro meters (μm), 9.5 μm, 11.2 μm, etc. The coherent radiation may have a coherent radiation spot size of 160 μm-280 μm, 150 μm-270 μm, etc. Accordingly, the coherent radiation 106 may have different combinations of wavelength, pulse duration, wave travel time, diffusion time, absorption length coherent radiation spot size, etc.

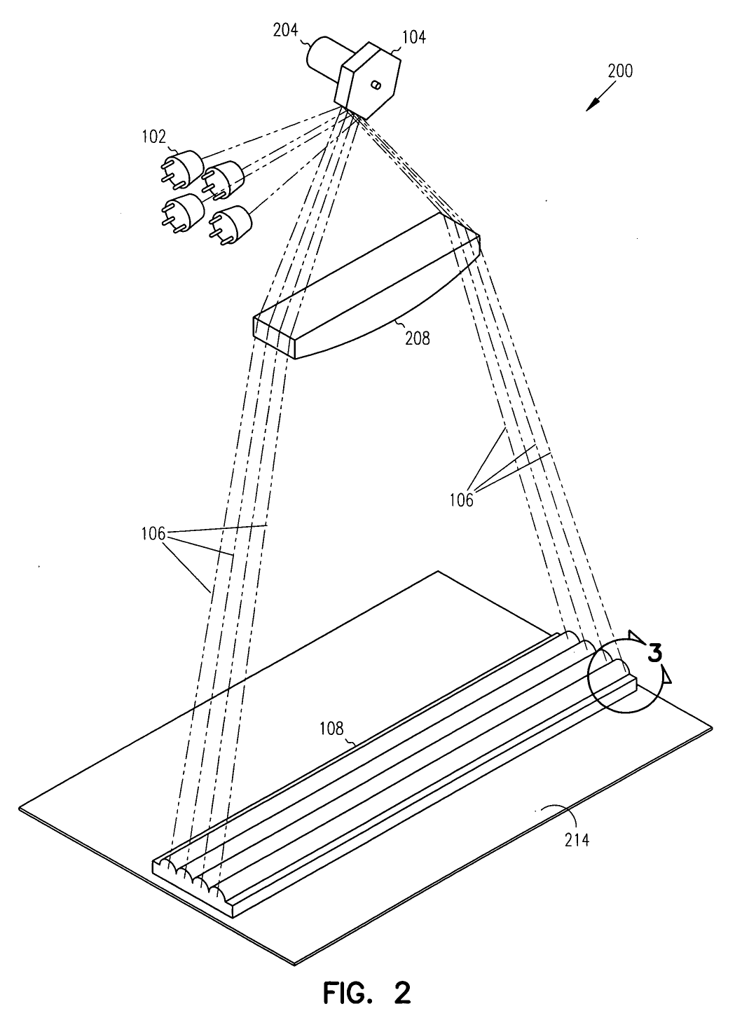

FIG. 2 illustrates a more detailed diagram of a system for fluid propelled by coherent radiation-induced blowing agents, according to some embodiments. In particular, FIG. 2 illustrates a system 200 that includes a coherent radiation source 102, a controller 204, a mirror 104, a lens 208 and a fluid ejection device 108. In operation, the coherent radiation source 102 emits the coherent radiation 106 that is reflected off the mirror 104 toward the fluid ejection device 108 through the lens 208. The controller 204 may control the mirror 104 such that the coherent radiation 106 is reflected off the mirror 104 toward different parts of the fluid ejection device 108. The controller 204 may be controlled by different types of control logic (as described above). The lens 208 focuses the coherent radiation 106 onto the fluid ejection device 108.

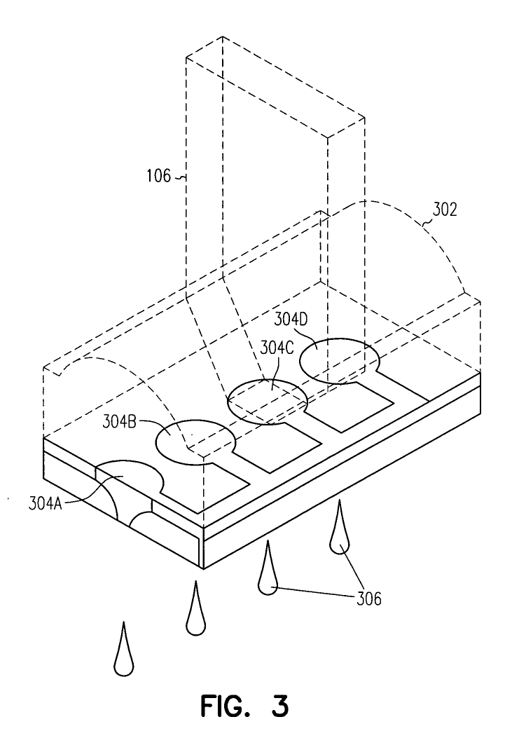

FIG. 3 illustrates a more detailed diagram of a fluid ejection device for fluid propelled by coherent radiation-induced blowing agents, according to some embodiments. In particular, FIG. 3 illustrates a more detailed block diagram of one embodiment of a part of the fluid ejection device 108 that is receiving the coherent radiation 106, which causes the expulsion of fluid droplets 306 from the fluid ejection device 108. The fluid ejection device 108 includes a lens 302 and reservoirs 304A-304D. The mirror 104 may reflect the coherent radiation onto one of the reservoirs 304A-304D through the lens 302. The reservoirs 304A-304D may store fluid that includes a blowing agent, which acts upon application of the energy supplied by the coherent radiation 106. In response, the blowing agent causes the fluid droplets to be expelled from the reservoir(s) 304. Different embodiments of the compositions of the fluid and blowing agent are described in more detail below.

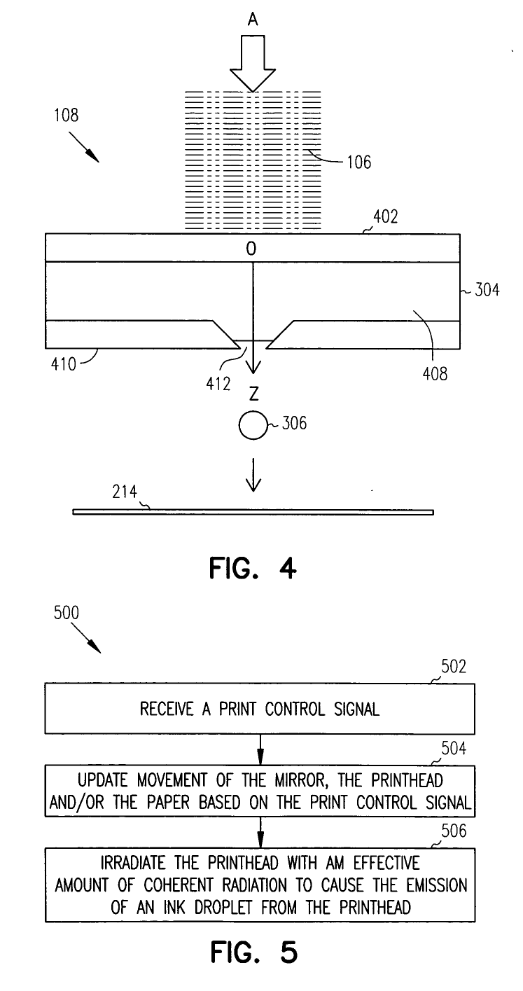

FIG. 4 illustrates a more detailed block diagram of an alternative view of a fluid ejection device for fluid propelled by coherent radiation-induced blowing agents, according to some embodiments. In particular, FIG. 4 illustrates a more detailed block diagram of one embodiment of the reservoir 304 within the fluid ejection device 108. The reservoir 304 includes a backing plate 402 and an orifice plate 410. The orifice plate 410 includes an orifice 412. In an embodiment, the backing plate 402 is approximately optically transparent. Accordingly, the coherent radiation 106 is emitted onto the backing plate 402, which causes the generation of a gas in the fluid 408, in an embodiment. In an embodiment, the generation of the gas in the fluid 408 serves as a blowing agent to cause the expulsion of the fluid droplet 306 from the reservoir 304 through the orifice 412 onto the paper 214. The orifice plate 410 may be made of a high surface energy material such as gold, and possibly nickel.

FIG. 5 illustrates a flow diagram of operations for propelling fluid by coherent radiation-induced blowing agents, according to some embodiments. In particular, FIG. 5 illustrates a flow diagram 500 that is described with reference to the system 200 of FIG. 2.

In block 502, a print control signal is received. With reference to the embodiment of FIG. 2, the coherent radiation source 102, the controller 204 and the fluid ejection device 108 receive the print control signal. The print control signal may be received from a number of different sources (not shown). For example, a microprocessor, different types of control logic, etc. may generate the print control signal. Control continues at block 504.

In block 504, movement of the coherent radiation source, the mirror and the fluid ejection device are controlled based on the print control signal. With reference to the embodiment of FIG. 2, the movement of the controller 204 is updated to cause the movement of the mirror 104 such that the coherent radiation 106 is reflected down to a different part of the fluid ejection device 108. For example, the movement of the mirror 104 may be such that the coherent radiation scans across the fluid ejection device 108. The movement of the paper 214 and/or fluid ejection device 108 may also be updated to allow for the receipt of the coherent radiation 106 at a different location relative to the paper 214. Control continues at block 506.

In block 506, the fluid ejection device is irradiated with an effective amount of coherent radiation to cause the emission of a fluid droplet from the fluid ejection device. With reference to the embodiment of FIG. 2, the coherent radiation source 102 emits the coherent radiation 106 that is reflected off the mirror 104. The coherent radiation 106 irradiates at least a part of the fluid ejection device 108.

While the flow diagram 500 illustrates a given order of operations, in some embodiments, such operations may be performed simultaneously, simultaneously in part and/or in a different order. For example, the operations in the blocks 504 and 506 may be performed at least simultaneously in part.

### Fluid

The fluid of some embodiments will typically include a dye (colorant), a fluid vehicle (carrier), and a blowing agent. Suitable dyes include, e.g., cyan, magenta, yellow and black. The fluid of some embodiments can optionally include at least one diol, at least one glycol ether, 2-pyrollidone, biocides, and buffers. The fluid of some embodiments can optionally include a combination of surfactants and inorganic salts, as described in U.S. Pat. No. 5,536,306; designed to reduce both color to color bleed as well as black to color bleed.

The amount of dye added to the vehicle is largely dependent upon solubility of the dye in the vehicle and the color intensity of the dye. Typical amounts of dye are between about 0.1 wt. % to about 5 wt. % of the fluid. In compositions of some embodiments, the dye is colored rather than black, although any of the dyes used in fluids for ink-jet printers may be employed. Illustrative suitable dyes include Direct Blue 199 (available form Zeneca Colors as Projet Cyan Special), Direct Red 9, Direct Red 227, Magenta 377 (available from Ilford AG, Rue de l'Industrie, CH-1700 Fribourg, Switzerland), Acid Yellow 23, Direct Yellow 86, Yellow 104 (Ilford AG), Direct Yellow 4 (BASF), Yellow PJY H-3RNA (Zeneca Colors), and Direct Yellow 50 (Zenceca Colors). In an embodiment, Direct Blue 199, Magenta 377, and Ilford Yellow 104 are employed as the cyan, magenta, and the yellow colorants.

The surfactant can include, e.g., secondary alcohol ethoxylate surfactant predominantly having about 4 to about 8 ethoxylated units and an aliphatic chain having about 12 to about 18 carbon atoms. The secondary alcohol ethoxylates serve to prevent color to color bleed by increasing the penetration of the fluids into the print medium. Secondary alcohol ethoxylates are nonionic surfactants and are commercially-available, for example, from Union Carbide Co. (Houston, Tex.) as the Tergitol series, such as Tergitol 15-S-5 and Tergitol 15-S-7. The secondary alcohol ethoxylates contain (a) an aliphatic chain having a prescribed number of carbon atoms in the chain and (b) a prescribed number of ethoxylated units. These ethoxylates are commercially available as mixtures of ethoxylates, and so are described in terms of the predominance of a given compound. Secondary alcohol ethoxylates suitably employed in some embodiments predominantly have about 12 to about 18 carbon atoms in the aliphatic chain, while the number of ethoxylated units is predominantly in the range of about 4 to about 8 units, and in the range of about 5 to about 7 units. Thus, “Tergitol 15-S-5” represents a secondary alcohol ethoxylate surfactant predominantly having 15 carbons in its aliphatic chain and 5 ethoxylated units. A mixture of secondary alcohol ethoxylates in which the predominant number of ethoxylated units is less than 4 is not very soluble in the fluid, while if the predominant number of ethoxylated units is greater than 8, the surfactant loses effectiveness in preventing color bleed.

The amount of the secondary alcohol ethoxylate employed in some embodiments is given by the sum of the two Tergitol components, 15-S-5 and 15-S-7, according to the formula
[15-S-5]+[15-S-7]=about 1 to 4 wt. %,
where the square brackets denote the concentration in weight percent. In an embodiment, Tergitol 15-S-5, without Tergitol 15-S-7, is present in the cyan and magenta fluids in the range of about 1.5 to 3 wt. % and in an embodiment about 1.5 to 2.5 wt. %. In the yellow fluid, a mixture of the two Tergitols is employed, with 15-S-5 ranging from about 0.5 to 2 wt. % and 15-S-7 ranging from about 1 to 2 wt. %; in an embodiment, the yellow fluid 15-S-5 ranges from about 0.8 to 1.2 wt. % and 15-S-7 ranges from about 1.3 to 1.7 wt. %.

Optionally, a second surfactant component may be employed in some embodiments, namely diphenyl sulfonate derivatives, which are anionic surfactants. Rather than address the problem of bleed, the presence of this second surfactant serves to correct a sporadic problem that results in mis-directed drops of fluid due to puddling of fluid on the nozzle plate as a consequence of different surface energies on the nozzle plate. The anionic surfactant apparently creates a substantially uniform surface energy and thus reduces the potential for mis-directed drops. An example of a suitably employed diphenyl sulfonate derivative is Dowfax 8390, available from Dow Chemical (Midland, Mich.). Dowfax 8390 is a sodium n-hexadecyl diphenyl oxide disulfonate. Other sources of such diphenyl sulfonate derivatives include Pilot Chemical (Calfax 16L35), Olin Chemical (Polytergent 4C3), and Sandoz Chemical (Sandoz Sulfonate 2A1). A diphenyl sulfonate derivative may include up to about 0.4 wt. % of the fluid, and includes about 0.3 to 0.4 wt. %.

The inorganic salt component of the present fluid serves to prevent bleed between black fluid and the color fluids, and includes one or more inorganic salts. The salts are soluble in the fluid in the concentration employed. Suitably-employed cations for the inorganic salt include alkaline earth metals of group 2A of the periodic table (e.g.. magnesium and calcium); the transition metals of group 3B of the periodic table (e.g., lanthanum); cations from group 3A of the periodic table (e.g., aluminum); and lanthanides (e.g., neodymium). Calcium and magnesium are employed as cations in some embodiments. Suitably-employed anions associated with calcium include nitrate, chloride, acetate, benzoate, formate, and thiocyanate, while suitable anions associated with magnesium include nitrate, chloride, acetate, benzoate, bromide, citrate, formate, iodide, sulfate, fluoride, tartrate, and thiocyanate. Inorganic salts employed in some embodiments are the nitrate, chloride, and acetate salts of calcium and magnesium. More specifically, the cyan and magenta fluids of some embodiments employ magnesium nitrate while the yellow fluid employs calcium nitrate.

Diols suitably employed in the present thermal fluid-jet fluid compositions include any of, or a mixture of two or more of, such compounds as ethanediols (e.g., 1,2-ethanediol); propanediols (e.g., 1,2-propanediol, 1,3-propanediol, 2-ethyl-2-hydroxy-methyl-1,3-propanediol, ethylhydroxy-propanediol (EHPD), etc.); butanediols (e.g., 1,3-butanediol, 1,4-butanediol, etc.); pentanediols (e.g., 1,5-pentanediol); and hexanediols (e.g., 1,6-hexanediol, 2,5-hexanediol, etc.). 1,5-pentanediol and EHPD are employed in some embodiments.

The glycol ether component of the fluid can include any of the glycol ethers and thioglycol ethers commonly employed in the fluids used in fluid-jet printing, or a mixture thereof. Examples of such compounds include polyalkylene glycols such as polyethylene glycols (e.g., diethylene glycol, triethylene glycol, tetraethylene glycol, etc.); polypropylene glycols (e.g., dipropylene glycol, tripropylene glycol, tetrapropylene glycol, etc.); polymeric glycols (e.g., PEG 200, PEG 300, PEG 400, PPG 400, etc.); and thiodiglycol. Diethylene glycol is employed in some embodiments.

The preferred concentration of pentanediol and glycol component in each fluid is given by of the formula
2×[DEG]+[pentanediol]=about 6 to 10 wt. %,
where the square brackets denote the concentration in weight percent. For the more preferred cyan and magenta fluids, DEG is absent and 1,5-pentanediol is present in the range of about 7 to about 9 wt. %, and in an embodiment about 7.5 to about 8.5 wt. %. For the more preferred yellow fluids, the amount of DEG ranges from about 3 to about 5 wt. % and in an embodiment about 3.5 to about 4.5 wt. %, and 1,5-pentanediol is absent.

EHPD is considered separately and is present in each fluid in an amount in the range of about 6 to about 9 wt. %. For the cyan and magenta fluids, EHPD is present within the range of about 7 to about 8 wt. %, while for the yellow fluid, EHPD is present within the range of about 7.5 to about 8.5 wt. %.

The other components of the present fluid, namely buffers, biocides, and the like, are each commonly employed additives in thermal fluid-jet fluid compositions.

Buffers employed in some embodiments to modulate pH should be organic-based biological buffers, since inorganic buffers would likely precipitate in the presence of the relatively large amount of inorganic salts in the fluid. Further, the buffer employed should provide a pH ranging from about 6 to 9 in some embodiments. Examples of employed buffers include Trizma Base, which is available from, for example, Aldrich Chemical (Milwaukee, Wis.), and 4-morpholine ethane sulfonic acid (MES).

Any of the biocides commonly employed in ink-jet inks may be employed in some embodiments, such as NUOSEPT 95, available from Hals America (Piscataway, N.J.); PROXEL GXL, available from ICI Americas (Wilmington, Del.); and glutaraldehyde, available from Union Carbide Company (Bound Brook, N.J.) under the trade designation UCARCIDE 250. PROXEL GXL is the preferred biocide.

Another optional component that may be employed in some embodiments is ammonium nitrate, which is used in conjunction with calcium-containing inorganic salts. Ammonium nitrate serves to prevent the precipitation of such calcium-containing inorganic salts in the fluid upon exposure to the carbon dioxide in the air.

Metal chelators optionally employed in some embodiments are used to bind transition metal cations that may be present in the fluid. Examples of employed metal chelators include: Ethylenediaminetetraacetic acid (EDTA), Diethylenetriaminepentaacetic acid (DTPA), trans-1,2-diaminocyclohexanetetraacetic acid (CDTA), (ethylenedioxy) diethylenedinitrilotetraacetic acid (EGTA), or other chelators that can bind transition metal actions. In an embodiment, EDTA, and DTPA, and, EDTA in its disodium salt form is employed in some embodiments.

The fluids of some embodiments include 0 to about 1.5 wt % metal chelator. In an embodiment, the fluids optionally include from about 0.1 to about 0.5 wt % metal chelator, with a concentration from about 0.1 to about 0.3 wt % in an embodiment.

Anti-kogation of the fluids is achieved by substitution of cations on certain dyes with other cations. For example, sodium cations associated with Direct Blue 199 (used in the cyan fluid) are substantially totally replaced with tetramethyl ammonium (TMA) cations, while sodium cations associated with Acid Red 52 (used in the magenta fluid) are substantially totally replaced with lithium cations and sodium cations associated with Acid Yellow 23 (used in the yellow fluid) are substantially totally replaced with TMA cations.

In some embodiments, cyan fluid is formulated by combining purified Acid Blue 9 and Direct Blue 199 anionic dyes with the above-described fluid vehicle, the latter dye being particularly known for providing high light fastness. Given the relatively high inorganic salt concentration in the cyan fluid, Direct Blue 199 associated with sodium or ammonium would likely precipitate out of the vehicle. Thus, Direct Blue 199 is treated to substantially replace all or most of the as-supplied sodium or ammonium cation with TMA cation. The Acid Blue 9 anionic dye may remain associated with sodium in some embodiments. The substitution of TMA in Direct Blue 199 reduces crusting about the orifice attributable to cyan fluid and enables the cyan fluid to remain in solution in the presence of a relatively high concentration of organic salts. Since the Acid Blue 9 anionic dye may remain associated with sodium in some embodiments, the amount of Acid Blue 9 is limited such that the presence of its associated sodium cation does not undo the benefits achieved by replacing the sodium or ammonium cation of Direct Blue 199 with TMA. In an embodiment, Direct Blue 199 and Acid Blue 9 are employed at concentrations ranging from about 2 to about 3 wt. % and 1 to about 2 wt. %, respectively. In a particular embodiment, the ratio of the concentration of Direct Blue 199 dye to the concentration of Acid Blue 9 dye in the present cyan fluid is about 2:1 by weight.

A variety of methods may be used to replace the sodium or ammonium ion associated with Direct Blue 199 with TMA. Examples of such ion-exchange processes are disclosed in U.S. Pat. Nos. 4,685,968 and 4,786,327, both assigned to the same assignee as embodiments. The method of forming the TMA form of the DB 199 dye forms no part.

Additional substances useful for fluids employed herein are described, e.g., in U.S. Pat. Nos. 5,788,754 and 5,536,306.

In an embodiment, the cyan fluid is prepared according to the following formulation and buffered to a pH of about 8:
(a) about 0.1 to 4 wt. % of a mixture of Direct Blue 199-TMA and Acid Blue 9-Na, with Direct Blue 199-TMA present at about 2 to 3 wt. %, in an embodiment, and Acid Blue 9-Na present at about 1 to 2 wt. % in an embodiment, with the ratio by weight of Direct Blue 199 to Acid Blue 9 being about 2:1 in an embodiment;
(b) a mixture of DEG and 1,5-pentanediol given by the formula
   2×[DEG+[pentanediol]=about 6 to 10 wt. %
   and about 6 to 9 wt. % ethylhydroxypropanediol (EHPD), with 1,5-pentanediol being present at about 7 to 9 wt. % (and DEG absent) in an embodiment, and about 7.5 to 8.5 wt. % in an embodiment, and with EHPD being present at about 7 to 8 wt. % of the fluid in an embodiment;
(c) about 3 to 9 wt. % of 2-pyrrolidone, with about 6 to 9 wt. % in an embodiment and about 7 to 8 wt. % in an embodiment;
(d) about 3 to 6 wt. % of a mixture of magnesium nitrate and/or calcium nitrate, with 4 to 5 wt. % magnesium nitrate alone in an embodiment;
(e) about 1 to 4 wt. % of a mixture of Tergitol 15-S-5 and/or Tergitol 15-S-7, with Tergitol 15-S-5 in an embodiment employed alone ranging from about 1.5 to 3 wt. % or, in an embodiment, 1.5 to 2.5 wt. %;
(f) up to about 0.4 wt. % of Dowfax 8390 surfactant, with about 0.3 to 0.4 wt. % in an embodiment;
(g) about 0.1 to 1 wt. % of a buffer, Trizma Base or MES;
(h) up to about 1 wt. % of a biocide, PROXEL GXL;
(i) up to about 5 wt.% Vazo® 52, Vazo® 64, Vazo® 67, Vazo® 88, Vazo® 44WSP, Vazo® 56WSP, Vazo® 56WSW, or Vazo® 68 wsp; and
(j) the balance water.

The magenta fluid employed in some embodiments is formulated by combining purified Reactive Red 180 in its hydrolized form and purified Acid Red 52 anionic dye with an fluid vehicle including the above-described components and concentration ranges. The Acid Red 52 anionic dye is treated to replace the as-supplied sodium cation with lithium. The ratio of the concentration of Reactive Red 180 to the concentration of Acid Red 52 in the present magenta fluid is about 1:1 by weight. Any of a variety of methods may be used to replace the sodium ion associated with Acid Red 52 with lithium, such as an ion-exchange process.

The magenta fluid is prepared according to the following formulation and is buffered to a pH of about 7:
(a) about 0.1 to 4 wt. % of a mixture of Reactive Red 180 and Acid Red 52-Li, with the ratio by weight of Reactive Red 180 to Acid Red 52 about 1:1 in an embodiment;
(b) a mixture of DEG and 1,5-pentanediol given by the formula
   2×[DEG]+[pentanediol]=about 6 to 10 wt. %
   and about 6 to 9 wt. % ethylhydroxypropanediol (EHPD), with 1,5-pentanediol present in an embodiment at about 7 to 9 wt. % (and DEG absent) and in an embodiment about 7.5 to 8.5 wt. %, and with EHPD being present at about 7 to 8 wt. % of the fluid;
(c) about 3 to 9 wt. % of 2-pyrrolidone, with about 6 to 9 wt. % in an embodiment and about 7 to 8 wt. % in an embodiment;
(d) about 3 to 6 wt. % of a mixture of magnesium nitrate and/or calcium nitrate, with 4 to 5 wt. % magnesium nitrate alone in an embodiment;
(e) about 1 to 4 wt. % of a mixture of Tergitol 15-S-5 and/or Tergitol 15-S-7, with Tergitol 15-S-5 in an embodiment employed alone ranging from about 1.5 to 3 wt. % or, in an embodiment, 1.5 to 2.5 wt. %;
(f) up to about 0.4 wt. % of Dowfax 8390 surfactant, with about 0.3 to 0.4 wt. % in an embodiment;
(g) about 0.1 to 1 wt. % of a buffer, Trizma base or MES;
(h) up to about 1 wt. % of a biocide, PROXEL GXL;
(i) up to about 5 wt.% Vazo® 52, Vazo® 64, Vazo® 67, Vazo® 88, Vazo® 44WSP, Vazo® 56WSP, Vazo® 56WSW, or Vazo® 68 wsp; and
(j) the balance water.

The yellow fluid employed in some embodiments is formulated by combining purified Acid Yellow 23 anionic dye with a fluid vehicle including the above-described components and concentration ranges. The Acid Yellow 23 anionic dye is treated to replace the as-supplied sodium cation with tetramethylammonium, which may be accomplished by a process such as ion-exchange. The method of forming the TMA form of the dye forms no part of this invention.

The yellow fluid is prepared according to the following formulation and buffered to a pH of about 6.5:
(a) about 0.1 to 4 wt. %. of Acid Yellow 23-TMA;
(b) a mixture of DEG and 1,5-pentanediol given by the formula
   2×[DEG]+[pentanediol]=about 6 to 10 wt. %
   and about 6 to 9 wt. % ethylhydroxypropanediol, with the DEG in an embodiment present in the mixture at about 3 to 5 wt. % (and 1,5 pentanediol absent) and in an embodiment about 3.5 to 4.5 wt. %, and the ethylhydroxypropanediol in an embodiment present at about 7.5 to 8.5 wt. %;
(c) about 3 to 9 wt. % of 2-pyrrolidone, with about 3 to 5 wt. % in an embodiment and about 3.5 to 4.5 wt. % in an embodiment;
(d) about 3 to 6 wt. % of a mixture of magnesium nitrate and/or calcium nitrate, with 4 to 5 wt. % calcium nitrate alone in an embodiment;
(e) about 1 to 4 wt. % of a mixture of Tergitol 15-S-5 and/or Tergitol 15-S-7, with a mixture of about 0.5 to 2 wt. % Tergitol 15-S-5 and about 1 to 2 wt. % Tergitol 15-S-7 in an embodiment or, in an embodiment, a mixture of about 0.8 to 1.2 wt. % Tergitol 15-S-5 and about 1.3 to 1.7 wt. % Tergitol 15-S-7;
(f) up to about 0.4 wt. % of Dowfax 8390 surfactant, with about 0.3 to 0.4 wt. % in an embodiment;
(g) about 0.1 to 1 wt. % of a buffer, Trizma base or MES;
(h) up to about 1 wt. % of a biocide, PROXEL GXL;
(i) up to 5 wt.% Vazo® 52, Vazo® 64, Vazo® 67, Vazo® 88, Vazo® 44WSP, Vazo® 56WSP, Vazo® 56WSW, or Vazo® 68 wsp; and
(j) the balance water.

Finally, the black fluid employed in the present fluid set may be any dye-based or a pigment-based fluid that is suitably employed in thermal ink-jet printing. Suitable black dye-based fluids are disclosed, for example, in U.S. Pat. No. 4,963,189. Suitable black pigment-based fluids are disclosed, for example, in U.S. Pat. Nos. 5,085,698; 5,221,334; and 5,302,197.

### Blowing Agent

As used herein, “blowing agent” refers to a material capable of decomposing, upon exposure to energy (e.g., heat or light), to generate a gas. See, e.g., Concise Chemical and Technical Dictionary, Fourth Enlarged Edition, Bennet, Chemical Publishing Co., NY, N.Y. (1986). In one embodiment, the blowing agent refers to a material capable of decomposing, upon being heated or upon being irradiated with an effective amount of coherent radiation (e.g., LASER), to generate a gas. The blowing agent can be a liquid, gas, or solid at standard temperature and pressure. Any suitable blowing agent can be employed, provided the blowing agent effectively decomposes, upon being irradiated with an effective amount of coherent radiation (e.g., LASER), to form a gas and when employed in fluid jet technology, can evolve the gas (e.g., nitrogen) to act as a blowing agent (e.g., to effectively cause the emission of a fluid droplet from the fluid ejection device).

In one embodiment, the blowing agent can have a decomposition temperature (with the resulting liberation of gaseous material) from about 80° C. to about 450° C. In another embodiment, the blowing agent can have a decomposition temperature (with the resulting liberation of gaseous material) from about 90° C. to about 350° C. In another embodiment, the blowing agent can have a decomposition temperature (with the resulting liberation of gaseous material) from about 110° C. to about 300° C.

The blowing agent can be an inorganic blowing agent or an organic blowing agent. Alternatively, the blowing agent can include an inorganic blowing agent and an organic blowing agent. The inorganic blowing agent can include, e.g., sodium bicarbonate, ammonium bicarbonate, ammonium carbonate, ammonia, nitrogen, inorganic azide compounds, or combinations thereof. Sodium borohydroxide and light metals can also generate gases, but are dangerous because they have a gas generation temperature of as high as 400° C., or the generated-gas species is hydrogen.

The organic blowing agent can include, e.g., azo compounds [e.g., Azodicarbonamide (ADCA), Azobisformamide, Azobisisobutyronitrile(AIBN), and Barium azodicarboxylate]; nitroso compounds [e.g., Dinitroso pentamethylene tetramine(DNPT), N,N′-Dimethyl-N,N′-dinitroso terephthalamide(DMDNTA), and N,N′-Dinitroso pentamethylene tetramine (DPT)]; sulfonyl hydrazides [e.g., 4,4′-Oxybis(benzenesulfonylhydrazide), a blend of benzene-1,3-disulfonyl hydrazide and chlorinated paraffin, Diphenylsulfone-3,3′-disulfohydrazide, p-Toluene sulfonyl aceton hydrazone, and p-Toluene sulfonylhydrazide(TSH)], semicarbazides [e.g., p-Toluene sulfonyl semicarbazide], tetrazoles [e.g., 5-Phenyl Tetrazole and Trihydrazinotriazine]; (C₁-C₁₂)hydrocarbons [e.g., acetylene, propane, propene, butane, butene, butadiene, isobutane, isobutylene, cyclobutane, cyclopropane, ethane, methane, ethene, pentane, pentene, cyclopentane, pentene, pentadiene, hexane, cyclohexane, hexene, hexadiene, and combinations thereof]; (C₁-C₁₂)organohalogens; (C₁-C₁₂)alcohols; (C₁-C₁₂)ethers; (C₁-C₁₂)esters; (C₁-C₁₂)amines; or combinations thereof.

Other suitable specific blowing agents include, e.g., neon, helium, butane, isobutane, 1,1-difluoroethane, p,p′-oxybis(benzene)sulfonyl hydrazide, p-toluene sulfonyl hydrazide, p-toluene sulfonyl semicarbazide, 5-phenyltetrazole, ethyl-5-phenyltetrazole, dinitroso pentamethylenetetramine, acetone, azodicarbonamide (AC), dinitroso pentamethylene tetramine (DNPT), Formacel® Z-2, Porofor®, Genitron®, Ficel®, Planagen®, HFC-245fa, Meforex® 134a, Meforex® 134b, HFC-365mfc, azodicarbonamide, acetone, Dinitrosopentamethylene tetramine, Exxsol® 1200, Exxsol® 1550, Exxsol® 1600, Exxsol® 2000, Exxsol® HP 95, Freon®V R-22 (HCFC), R-11 (CFC), R-12 (CFC), R-113 (CFC), R-141 (HCFC), R-22 (HCFC), R-HFC 134a, HFC-134a; SUVA® (DuPont), Dymel® (DuPont), Formacel® (DuPont), Zyron® (DuPont), Porofor® (Bayer), Genitron® (Bayer), Ficel® (Bayer), Planagen® (Bayer), Meforex® 134a (Ausimont), Meforex® 141b (Ausimont), HFC-245fa (Ausimont), HFC-365mfc (Ausimont), acetone, Exxsol® 1200 (Exxon Mobil), Exxsol® 1550 (Exxon Mobil), Exxsol® 1600 (Exxon Mobil), Exxsol® 2000 (Exxon Mobil), Exxsol® HP 95 (Exxon Mobil), Freont R-22 (HCFC) (Foam-Tech), Freon® R-11 (CFC) (Foam-Tech), and HFC-Freon® 134a (Foam-Tech).

Other suitable blowing agents are disclosed, e.g., in Aldrich Handbook of Fine Chemicals (Milwaukee, Wis.).

In one embodiment, the blowing agent can include an organic blowing agent. In another embodiment, the blowing agent can include an azo compound (e.g., a substituted diazo compound). Suitable diazo blowing agents include compounds of the general formula:
R—N═N—R
wherein,
each R is independently an acyclic (aliphatic), cyclic, saturated, partially unsaturated or aromatic hydrocarbon (e.g., alkyl, cycloalkyl, heterocycle, aryl, heteroaryl, cycloalkyl alkyl, heterocycle alkyl, aryl alkyl, heteroaryl or alkyl) optionally substituted with one or more (e.g., 1, 2, or 3) alkyl, hydroxy, alkoxy, cyano, nitro, halo, SR^{x}, NR^{x}R^{x}, (═NR^{x}), or COOR^{x}, and wherein any hydrocarbon is optionally interrupted with one or more (e.g., 1, 2, or 3) O, N, C(═O), SO₂, SO, C(═O)NR^{x}, C(═O)O, NR^{x}C(═O), or OC(═O); wherein each R^{x} is independently H or alkyl; or suitable salts thereof.

In one embodiment, the blowing agent can include Vazo® free radical initiators (FRSs), which are commercially available from DuPont (Wilmington, Del.). Vazo® free radical initiators (FRSs) include, e.g., Vazo® 52, Vazo® 64, Vazo® 67, Vazo® 88, Vazo® 44WSP, Vazo® 56WSP, Vazo® 56WSW, and Vazo® 68 wsp.

Vazo® 52 refers to a compound of the formula:

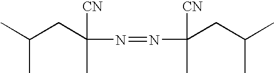

Vazo® 64 refers to a compound of the formula:

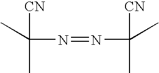

Vazo® 67 refers to a compound of the formula:

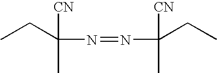

Vazo® 88 refers to a compound of the formula:

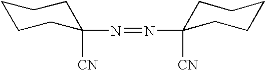

Vazo® 44 refers to a compound of the formula

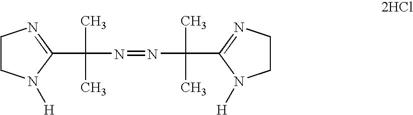

Vazo® 56 refers to a compound of the formula:

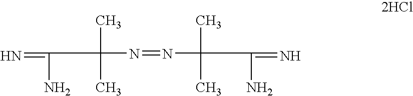

Vazo® 68 refers to a compound of the formula:

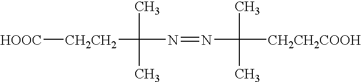

In one embodiment, the blowing agent is at least partially soluble in aqueous medium. In another embodiment, the blowing agent is at least partially soluble is organic medium. In another embodiment, the blowing agent is at least partially soluble in polar protic solvents (e.g., water and alcohols such as methanol, ethanol, isopropanol, ethylene glycol, propylene glycol, poly(ethylene)glycol, etc.). In another embodiment, the blowing agent is at least partially soluble in non-polar, aprotic solvents (e.g., hydrocarbons such as benzene, toluene, pentane, etc.). In another embodiment, the blowing agent is at least partially soluble in polar aprotic solvents such as ethyl acetate, acetone, etc.).

The blowing agent can be employed in any suitable and appropriate amount. Specifically, blowing agent can be employed in any amount provided the blowing agent effectively decomposes, upon being irradiated with an effective amount of coherent radiation (e.g., LASER), to form a gas and when employed in fluidjet technology, can evolve the gas (e.g., nitrogen) to act as a blowing agent (e.g., to effectively cause the emission of a fluid droplet from the fluid ejection device). For example, the blowing agent can be employed up to about 50 wt. % of the fluid, up to about 40 wt. % of the fluid, or up to about 30 wt. % of the fluid. Typically, the blowing agent can be employed in about 0.1 wt. % of the fluid to about 10 wt. % of the fluid, in about 3.0 wt. % of the fluid to about 4.2 wt. % of the fluid, or in about 3.5 wt. % to about 4.0 wt. % of the fluid.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

A number of figures show block diagrams of systems and apparatus for propelling of fluid using coherent radiation-induced blowing agents, according to some embodiments. A figure shows a flow diagram illustrating operations for propelling of fluid using coherent radiation-induced blowing agents, according to some embodiments. The operations of the flow diagram are described with references to the systems/apparatus shown in the block diagrams. However, it should be understood that the operations of the flow diagram could be performed by embodiments of systems and apparatus other than those discussed with reference to the block diagrams, and embodiments discussed with reference to the systems/apparatus could perform operations different than those discussed with reference to the flow diagram.

In view of the wide variety of permutations to the embodiments described herein, this detailed description is intended to be illustrative only, and should not be taken as limiting the scope. What is claimed as the invention, therefore, is all such modifications as may come within the scope and spirit of the following claims and equivalents thereto. Therefore, the specification and drawings are to be regarded in an illustrative rather than a restrictive sense.

1. A method comprising:
irradiating a fluid ejection device with an effective amount of coherent radiation to cause emission of a fluid droplet from the fluid ejection device, wherein the fluid droplet includes a blowing agent.

2. The method of claim 1 wherein the fluid droplet includes a dye that is about 0.1 wt. % to about 5 wt. % of the fluid droplet.

3. The method of claim 1 wherein the fluid droplet includes a dye that comprises Direct Blue 199, Direct Red 9, Direct Red 227, Magenta 377, Acid Yellow 23, Direct Yellow 86, Yellow 104, Direct Yellow 4, Yellow PJY H-3RNA, Direct Yellow 50, or a combination thereof.

4. The method of claim 1 wherein the blowing agent is an azo compound, a nitroso compound, a sulfonyl hydrazide, a semicarbazide, or a tetrazole.

5. The method of claim 1 wherein the blowing agent is an azo or diazo organic compound.

6. The method of claim 1 wherein the blowing agent comprises a compound of the formula
R—N═N—R
wherein,
each R is independently an acyclic, cyclic, saturated, partially unsaturated or aromatic hydrocarbon optionally substituted with one or more alkyl, hydroxy, alkoxy, cyano, nitro, halo, SR^{x}, NR^{x}R^{x}, (═NR^{x}), or COOR^{x}, and wherein the hydrocarbon is optionally interrupted with one or more O, N, C(═O), SO₂, SO, C(═O)NR^{x}, C(═O)O, NR^{x}C(═O), or OC(═O); wherein each Rx is independently H or alkyl; or a suitable salt thereof.

7. The method of claim 1 wherein the blowing agent comprises a compound of formula (I) to (VII): 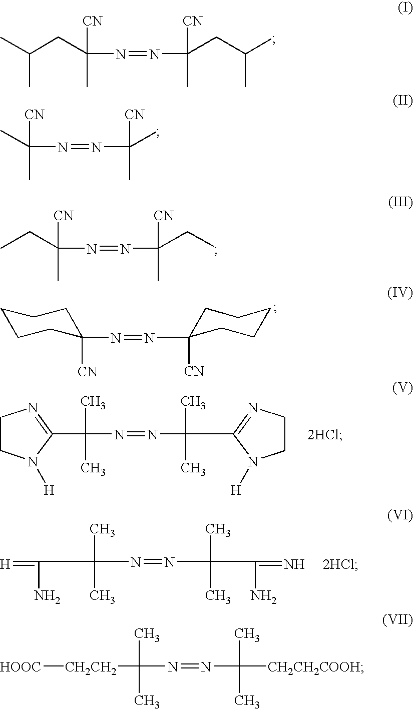
a suitable salt thereof, or any combination thereof.

8. The method of claim 1, wherein irradiating the fluid ejection device with the effective amount of coherent radiation includes irradiating the fluid ejection device with the effective amount of a LASER signal.

9. The method of claim 1, further comprising:
receiving a print control signal; and
controlling movement of a mirror to reflect the coherent radiation to a part of the fluid ejection device.

10. A system comprising:
a printhead;
ink including a blowing agent; and
a coherent radiation source to emit a coherent radiation that is to irradiate the printhead.

11. The system of claim 10 wherein the ink includes dye, and the dye is present in about 0.1 wt. % to about 5 wt. % of the ink.

12. The system of claim 10 wherein the dye comprises Direct Blue 199, Direct Red 9, Direct Red 227, Magenta 377, Acid Yellow 23, Direct Yellow 86, Yellow 104, Direct Yellow 4, Yellow PJY H-3RNA, Direct Yellow 50, or a combination thereof.

13. The system of claim 10 wherein the blowing agent is an azo compound, a nitroso compound, a sulfonyl hydrazide, a semicarbazide, or a tetrazole.

14. The system of claim 10 wherein the blowing agent is an azo or diazo organic compound.

15. The system of claim 10 wherein the blowing agent comprises a compound of the formula
R—N═N—R
wherein,
each R is independently an acyclic, cyclic, saturated, partially unsaturated or aromatic hydrocarbon optionally substituted with one or more alkyl, hydroxy, alkoxy, cyano, nitro, halo, SR^{x}, NR^{x}R^{x}, (═NR^{x}), or COOR^{x}, and wherein the hydrocarbon is optionally interrupted with one or more O, N, C(═O), SO₂, SO, C(═O)NR^{x}, C(═O)O, NR^{x}C(═O), or OC(═O); wherein each Rx is independently H or alkyl; or a suitable salt thereof.

16. The system of claim 10 wherein the blowing agent comprises a compound of formula (I) to (VII): 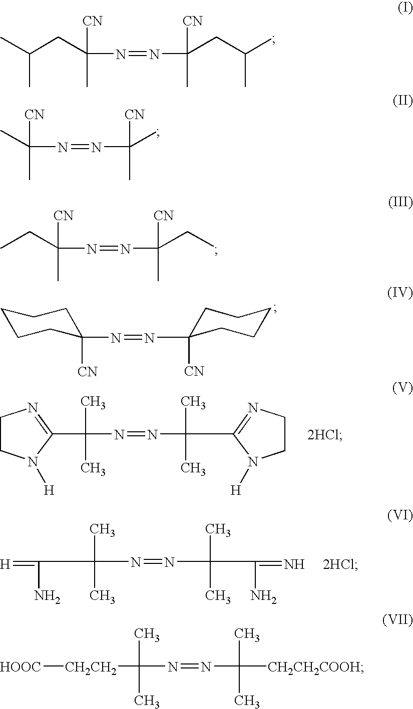
a suitable salt thereof, or any combination thereof.

17. An apparatus comprising:
a fluid ejection device that includes a reservoir to store a fluid that includes a blowing agent.

18. The apparatus of claim 17 wherein the fluid includes a dye, wherein the dye is present in about 0.1 wt. % to about 5 wt. % of the fluid.

19. The apparatus of claim 17 wherein the fluid includes a dye, wherein the dye comprises Direct Blue 199, Direct Red 9, Direct Red 227, Magenta 377, Acid Yellow 23, Direct Yellow 86, Yellow 104, Direct Yellow 4, Yellow PJY H-3RNA, Direct Yellow 50, or a combination thereof.

20. The apparatus of claim 17 wherein the blowing agent is an azo compound, a nitroso compound, a sulfonyl hydrazide, a semicarbazide, or a tetrazole.

21. The apparatus of claim 17 wherein the blowing agent is an azo or diazo organic compound.

22. The apparatus of claim 17 wherein the blowing agent comprises a compound of the formula
R—N═N—R
wherein,
each R is independently an acyclic, cyclic, saturated, partially unsaturated or aromatic hydrocarbon optionally substituted with one or more alkyl, hydroxy, alkoxy, cyano, nitro, halo, SR^{x}, NR^{x}R^{x}, (═NR^{x}), or COOR^{x}, and wherein the hydrocarbon is optionally interrupted with one or more O, N, C(═O), SO₂, SO, C(═O)NR^{x}, C(═O)O, NR^{x}C(═O), or OC(═O); wherein each R^{x} is independently H or alkyl; or a suitable salt thereof.

23. The apparatus of claim 17 wherein the blowing agent comprises a compound of formula (I) to (VII): 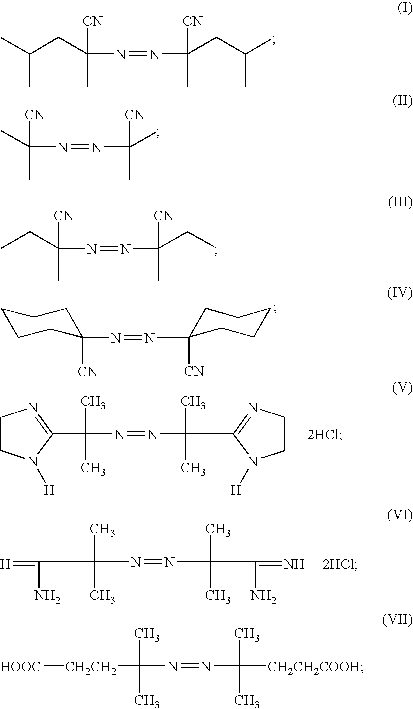
a suitable salt thereof, or any combination thereof.

24. An ink, for ink-jet printing, comprising:
(a) a dye or colorant;
(b) an ink vehicle or carrier; and
(c) a blowing agent.

25. The ink of claim 24 wherein the dye is present in about 0.1 wt. % to about 5 wt. % of the ink.

26. The ink of claim 24 wherein the dye comprises Direct Blue 199, Direct Red 9, Direct Red 227, Magenta 377, Acid Yellow 23, Direct Yellow 86, Yellow 104, Direct Yellow 4, Yellow PJY H-3RNA, Direct Yellow 50, or a combination thereof.

27. The ink of claim 24 wherein the blowing agent is an azo compound, a nitroso compound, a sulfonyl hydrazide, a semicarbazide, or a tetrazole.

28. The ink of claim 24 wherein the blowing agent is an azo or diazo organic compound.

29. The ink of claim 24 wherein the blowing agent comprises a compound of the formula
R—N═N—R
wherein,
each R is independently an acyclic, cyclic, saturated, partially unsaturated or aromatic hydrocarbon optionally substituted with one or more alkyl, hydroxy, alkoxy, cyano, nitro, halo, SR^{x}, NR^{x}R^{x}, (═NR^{x}), or COOR^{x}, and wherein the hydrocarbon is optionally interrupted with one or more O, N, C(═O), SO₂, SO, C(═O)NR^{x}, C(═O)O, NR^{x}C(═O), or OC(═O); wherein each R^{x} is independently H or alkyl; or a suitable salt thereof.

30. The ink of claim 24 wherein the blowing agent comprises a compound of formula (I) to (VII): 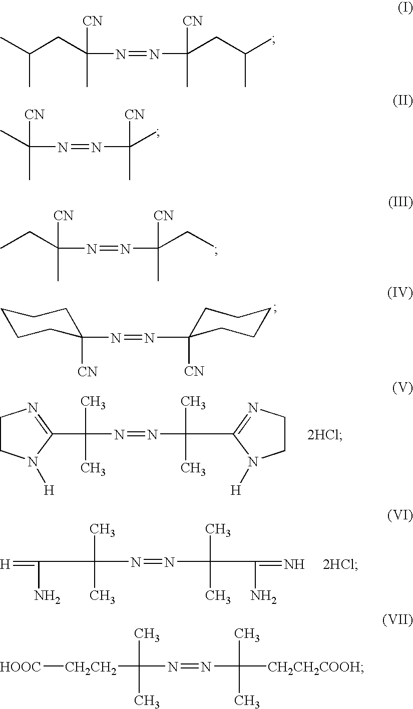
a suitable salt thereof, or any combination thereof.

31. A method comprising:
emitting coherent radiation to a fluid ejection device, the fluid ejection device having a reservoir with fluid; and
generating gas in the reservoir to expel fluid from the fluid ejection device.

32. The method of claim 31 wherein generating gas serves as a blowing agent to expel the fluid.
